(19) United States
(12) Patent Application Publication
(10) Pub. No.: US 2013/0064146 A1
(43) Pub. Date: Mar. 14, 2013

(54) DIRECT CONNECTION COMMUNICATION BETWEEN TERMINALS AND METHOD FOR DIRECTLY TRANSMITTING AND RECEIVING DATA BETWEEN TERMINALS FOR A TERMINAL RELAY

(71) Applicants: Jae Young Ahn, Daejeon (KR); Joon Woo Shin, Chungbuk (KR)

(72) Inventors: Jae Young Ahn, Daejeon (KR); Joon Woo Shin, Chungbuk (KR)

(73) Assignee: ELECTRONICS AND TELECOMMUNICATIONS RESEARCH INSTITUTE, Daejeon (KR)

(21) Appl. No.: 13/698,570

(22) PCT Filed: May 17, 2011
(86) PCT No.: PCT/KR2011/003614

§ 371 Date: Nov. 16, 2012

(30) Foreign Application Priority Data
May 18, 2010 (KR) 10-2010-0046559

(51) Int. Cl. H04W 72/04; H04J 3/00; H04J 1/00

(52) U.S. Cl. 370/280; 370/281

(57) ABSTRACT

Disclosed is a method for directly transmitting and receiving data between terminals in a frequency division duplexing (FDD)-type and time division duplexing (TDD)-type mobile communication system. For FDD-type systems, provided are methods for performing direct data transmission and reception between terminals on the basis of a downlink subframe time interval and methods for performing direct data transmission and reception between terminals on the basis of an uplink subframe time interval. For TDD-type systems, provided are methods for performing direct data transmission and reception between terminals in a downlink subframe and methods for performing direct data transmission and reception between terminals in an uplink subframe. Additionally, for each method, provided are systems for performing only reception or transmission in one subframe and systems for performing both reception and transmission in one subframe.

### TECHNICAL FIELD

The present invention relates to a data transmission/reception method of a wireless communication system, and more particularly to a method of directly transmitting/receiving data between adjacent terminals without passing through a base station in a wireless communication system based on orthogonal frequency division multiplexing (OFDM).

### BACKGROUND ART

When data is transmitted/received between adjacent terminals in a wireless communication system having a point-to-multipoint structure, transmission from a terminal to a base station and retransmission from the base station to an opposite terminal should be performed, and thus there is a problem in that the waste of radio resources and a transfer delay are increased as compared with the case where the terminals exchange data with each other. In order to solve this problem, terminal-to-terminal direct communication (device-to-device communication or D2D communication) technology has appeared.

That is, the terminal-to-terminal direct communication is a communication scheme of performing direct data transmission/reception between two adjacent terminals without passing through a base station. That is, communication is performed in a state in which the two terminals become a source and a destination, respectively.

FIG. 1 is a conceptual diagram illustrating a concept of terminal-to-terminal direct communication.

Referring to FIG. 1, a cellular communication network is constituted by a first base station 110 and a second base station 120. In this case, a terminal 1 (111) to a terminal 3 (113) belonging to a cell generated by the first base station 110 perform communication through a general connection link of the first base station 110, but a terminal 4 (114) and a terminal 5 (115) belonging to the first base station 110 directly transmit/receive data to/from each other without passing through the base station.

Various discussions are possible for user cases where the above-described terminal-to-terminal direct communication can be efficiently used. For example, the terminal-to-terminal direct communication may be used in a local media server or the like that provides a large volume of materials (for example, information regarding a program and a player of a rock concert) to visitors visiting a rock concert or the like. At this time, each device is connected to a serving cell, a phone call, Internet access, and the like are made using a cellular link of the related art, and the above-described large volume of materials may be directly transmitted/received to/from the local media server operating as a D2D communication partner by the D2D scheme.

On the other hand, again referring to FIG. 1, a D2D link may be established not only between devices having the same cell as a serving cell, but also between devices having different cells as serving cells. For example, the terminal 3 (113) belonging to the first base station 110 may also perform D2D communication with a terminal 6 (121) belonging to the second base station 120.

This D2D link may be established by a communication scheme using a non-licensed band of a wireless LAN or Bluetooth based on IEEE 802.11 or the like, but there is a disadvantage in that it is difficult for the communication scheme using the non-licensed band to provide a planned and controlled service. In particular, a situation in which performance is rapidly degraded by interference may occur.

On the other hand, in the case of D2D communication provided in a wireless communication system using a TV white space band operating in an environment where a licensed band or interference between systems is controlled, there is an advantage in that QoS can be supported, frequency use efficiency can be increased through frequency reuse in a D2D link, and a D2D communicable distance can be increased.

Meanwhile, terminal (user equipment (UE))-based relay communication is a scheme in which a peripheral terminal (terminal B) having a good characteristic in a link with a peripheral base station, that is, located closer to the base station or exiting a dead zone, serves to relay data between a terminal A and the base station so as to increase the transmission capacity of the terminal (terminal A) located in a cell boundary or the dead zone. At this time, the terminal A may be a data source and/or destination.

The terminal-based relay communication is performed through a cellular link between a base station and a device (relay device) serving as a relay and a D2D link between the relay device and a terminal (end terminal) that receives a relay service.

There is an advantage in that terminal-based relaying can improve the transmission capacity of a terminal in a cell boundary and the frequency use efficiency of the entire cell may be increased through frequency reuse in a D2D link.

On the other hand, for the terminal-to-terminal direct communication and terminal-based relay communication, the structures of transmission and reception units of terminals joining terminal-to-terminal direct communication and characteristics of the transmission and reception units should be decided, and a terminal-to-terminal data transmission/reception method should be decided.

### DISCLOSURE

### Technical Problem

Therefore, a first object of the present invention is to provide a terminal-to-terminal direct data transmission/reception method of a terminal having transmission and reception units in a mobile communication system based on frequency division duplexing (FDD) (frequency division multiplexing).

Also, a second object of the present invention is to provide a terminal-to-terminal direct data transmission/reception method of a terminal in a mobile communication system based on time division duplexing (TDD) (time division multiplexing).

### Technical Solution

To accomplish the first object of the present invention described above, one aspect of the present invention provides a terminal-to-terminal direct data transmission/reception method of a terminal having a transmission unit and a reception unit in a mobile communication system based on frequency division duplexing (FDD) (frequency division multiplexing), including the steps of: (a) receiving, by the reception unit, a downlink control channel; (b) after step (a), changing, by the reception unit, a reception frequency to an uplink frequency, and changing, by the transmission unit, a transmission frequency to a downlink frequency; (c) receiving, by the reception unit, data from another terminal at the uplink frequency, or transmitting, by the transmission unit, data to another terminal at the downlink frequency; and (d) re-changing, by the reception unit, the reception frequency to the downlink frequency, and re-changing, by the transmission unit, the transmission frequency to the uplink frequency.

A point in time when step (d) is performed may be an end time of a current subframe or a time within a subframe subsequent to the current subframe, and the terminal may only perform transmission to another terminal within one downlink subframe, and/or reception from another terminal within one uplink subframe.

Step (d) may be performed within a current subframe time interval, and the terminal-to-terminal direct data transmission/reception method may further include the step of: (e) after step (d), receiving, by the reception unit, data from another terminal at the downlink frequency, and/or transmitting, by the transmission unit, data to another terminal at the uplink frequency, within the subframe time interval.

The terminal may simultaneously directly transmit/receive data to/from a plurality of terminals within the same subframe.

A plurality of terminals may simultaneously receive data transmitted from the terminal to other terminals at the downlink frequency.

To accomplish the first object of the present invention described above, another aspect of the present invention provides a terminal-to-terminal direct data transmission/reception method of a terminal having a transmission unit and a reception unit in a mobile communication system based on FDD (frequency division multiplexing), including the steps of: (a) changing, by the reception unit, a reception frequency to an uplink frequency, and changing, by the transmission unit, a transmission frequency to a downlink frequency, at or before a subframe start time; (b) after step (a), receiving, by the reception unit, data from another terminal at the uplink frequency, or transmitting, by the transmission unit, data to another terminal at the downlink frequency after staying in an idle state during a subframe downlink control channel interval; and (c) re-changing, by the reception unit, the reception frequency to the downlink frequency, and re-changing, by the transmission unit, the transmission frequency to the uplink frequency.

A point in time when step (c) is performed may be an end time of a current subframe or a time within a subframe subsequent to the current subframe, and the terminal may only perform transmission to another terminal within one downlink subframe and/or reception from another terminal within one uplink subframe.

A point in time when step (c) is performed may be within a current subframe time interval, and the terminal-to-terminal direct data transmission/reception method may further include the step of: (d) after step (c), receiving, by the reception unit, data from another terminal at the downlink frequency, and/or transmitting, by the transmission unit, data to another terminal at the uplink frequency, within the subframe time interval.

The terminal may simultaneously directly transmit/receive data to/from a plurality of terminals within the same subframe.

A plurality of terminals may simultaneously receive data transmitted from the terminal to other terminals at the downlink frequency or the uplink frequency.

To accomplish the second object of the present invention described above, one aspect of the present invention provides a terminal-to-terminal direct data transmission/reception method of a terminal within a downlink subframe in a mobile communication system based on time division duplexing (TDD) (time division multiplexing), including the steps of: (a) receiving a downlink control channel from a base station; (b) after step (a), transmitting data to another terminal by switching to a transmission mode; and (c) switching to a reception mode if a subframe next to a current subframe is a downlink subframe.

A point in time when step (c) is performed may be an end time of the current subframe or a time within the subframe subsequent to the current downlink subframe.

Step (c) may be performed within a current subframe time interval, and the terminal-to-terminal direct data transmission/reception method may further include the step of: after step (c), receiving data from another terminal within a current downlink subframe time interval.

The terminal may simultaneously directly transmit data to a plurality of terminals within the same subframe.

A plurality of terminals may simultaneously receive data transmitted from the terminal to other terminals in a transmission mode.

To accomplish the second object of the present invention described above, another aspect of the present invention provides a terminal-to-terminal direct data transmission/reception method of a terminal within an uplink subframe in a mobile communication system based on TDD (time division multiplexing), including the steps of: (a) switching to a reception mode at or before a start time of an uplink subframe; (b) after step (a), receiving data from another terminal; and (c) switching to a transmission mode if a subframe next to a current subframe is an uplink subframe.

A point in time when step (c) is performed may be an end time of a current subframe or a time within a subframe subsequent to the current subframe.

Step (c) may be performed within a current subframe time interval, and the terminal-to-terminal direct data transmission/reception method may further include the step of: after step (c), transmitting data to another terminal within a current uplink subframe time interval.

The terminal may simultaneously directly transmit/receive data to/from a plurality of terminals within the same subframe.

### Advantageous Effects

If a terminal-to-terminal direct data transmission/reception method according to the present invention as described above is used, direct data transmission/reception between adjacent terminals is possible without passing through a base station, so that the waste of radio resources and a transfer delay for communication between a base station and a terminal can be reduced. In particular, the data transmission/reception method according to the present invention is applicable to terminal-to-terminal direct communication or terminal-based relaying.

### DESCRIPTION OF DRAWINGS

FIG. 1 is a conceptual diagram illustrating a concept of terminal-to-terminal direct communication.

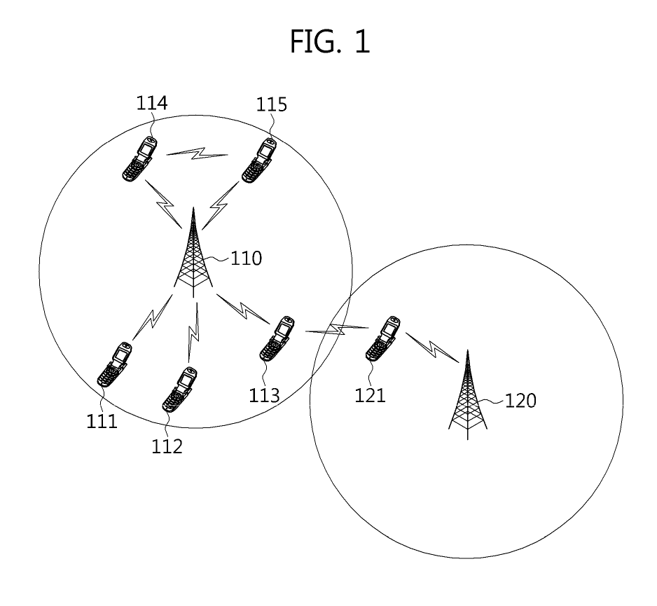

FIG. 2 is a flowchart illustrating a method of performing terminal-to-terminal direct communication on the basis of all time intervals in which downlink subframe data transmission is possible in a frequency division duplexing (FDD) system according to the present invention.

FIG. 3 is a frame structure diagram illustrating a scheme of performing only transmission to another terminal or reception from another terminal using a downlink (or uplink) frequency in one subframe.

FIG. 4 is a frame structure diagram illustrating a scheme of performing both transmission to another terminal and reception from another terminal using a downlink (or uplink) frequency in one subframe.

FIG. 5 is a flowchart illustrating a method of performing terminal-to-terminal direct communication on the basis of all time intervals in which uplink subframe data transmission is possible in an FDD system according to the present invention.

FIG. 6 is a frame structure diagram illustrating a scheme of performing only transmission to another terminal or reception from another terminal using a downlink (or uplink) frequency in one subframe.

FIG. 7 is a frame structure diagram illustrating a scheme of performing both transmission to another terminal and reception from another terminal using a downlink or uplink frequency in one subframe.

FIG. 8 is a flowchart illustrating a method of performing terminal-to-terminal direct communication within a downlink subframe in a time division duplexing (TDD) system according to the present invention.

FIG. 9 is a frame structure diagram illustrating a scheme of performing only transmission to another terminal or reception from another terminal on the basis of all time intervals in which downlink subframe data transmission is possible.

FIG. 10 is a frame structure diagram illustrating a scheme of performing both transmission to another terminal and reception from another terminal on the basis of all time intervals in which downlink subframe data transmission is possible.

FIG. 11 is a flowchart illustrating a method of performing terminal-to-terminal direct communication within an uplink subframe in a TDD system according to the present invention.

FIG. 12 is a frame structure diagram illustrating a scheme of performing only transmission to another terminal or reception from another terminal on the basis of all time intervals in which uplink subframe data transmission is possible.

FIG. 13 is a frame structure diagram illustrating a scheme of performing both transmission to another terminal and reception from another terminal in an uplink subframe.

### BEST MODE

While the present invention is susceptible to various modifications and alternative forms, specific embodiments thereof are shown by way of example in the drawings and will herein be described in detail.

It should be understood, however, that there is no intent to limit the invention to the particular forms disclosed, but on the contrary, the invention is to cover all modifications, equivalents, and alternatives falling within the spirit and scope of the invention.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the related art and will not be interpreted in an idealized or overly formal sense unless expressly so defined herein.

The term “terminal” used herein may be referred to as a mobile station (MS), UE, user terminal (UT), wireless terminal, access terminal (AT), subscriber unit, subscriber station (SS), wireless device, wireless communication device, wireless transmit/receive unit (WTRU), mobile node, mobile, or other terms. Various embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited thereto.

The term “base station” used herein generally denotes a fixed or mobile point that communicates with a terminal, and may be referred to as a Node-B, evolved Node-B (eNB), base transceiver system (BTS), access point, relay, femto-cell, and other terms.

Hereinafter, preferred embodiments of the present invention will be described in more detail with reference to the accompanying drawings. To facilitate the entire understanding of the invention, the same reference numerals in the drawings denote the same elements, and repetitive description of the same elements is omitted.

Transmission Scheme and Terminal Structure for Terminal-to-Terminal Direct Data Transmission/Reception

Before a description of a terminal-to-terminal direct data transmission/reception method, uplink and downlink transmission schemes and a terminal structure for terminal-to-terminal direct data transmission/reception will be first described.

In general, an orthogonal frequency division multiplexing (OFDM)-based wireless communication system having a point-to-multipoint structure uses an orthogonal frequency division multiple access (OFDMA) scheme in the downlink and uses an OFDMA, single-carrier frequency division multiple access (SC-FDMA), or discrete Fourier transform-spread orthogonal frequency division multiplexing (DFT-spread OFDM) scheme in the uplink. For example, a 3rd Generation Partnership Project (3GPP) long term evolution (LTE) or LTE-advanced wireless communication system is included as the wireless communication system. A terminal includes one downlink reception unit and one uplink reception unit.

Accordingly, if the terminal-to-terminal direct data transmission/reception is performed using a downlink resource, transmission/reception may be performed in the same OFDMA scheme as that of the downlink between a base station and a terminal in communication between adjacent terminals using the downlink resource. Alternatively, in the communication between the adjacent terminals using the downlink resource, transmission/reception may be performed in the same scheme (OFDMA, SC-FDMA, or DFT-spread OFDM) as that of the uplink between the terminal and the base station.

If the terminal-to-terminal direct data transmission/reception is performed using an uplink resource, transmission/reception may be performed in the same scheme (OFDMA, SC-FDMA, or DFT-spread OFDM) as that of the uplink between a terminal and a base station in communication between adjacent terminals using the uplink resource. Alternatively, in the communication between the adjacent terminals using the uplink resource, transmission/reception may be performed in the same OFDMA scheme as that of the downlink between the base station and the terminal.

Meanwhile, in general, the terminals respectively serve as one reception unit and one transmission unit to support data transmission/reception between the base station and the terminals and terminal-to-terminal direct data transmission/reception without adding a separate transmission/reception unit so as to reduce an increase in complexity of a terminal in a state in which the data transmission/reception between a base station and terminals and the terminal-to-terminal direct data transmission/reception are possible. In this case, the transmission and reception units of the terminal may have the following structures.

1) Reception Unit

The reception unit may have one of a structure that supports only reception of the downlink scheme and a structure that supports reception of both the downlink and uplink schemes. Here, only a downlink transmission scheme may be used for terminal-to-terminal communication if the reception unit has the structure that supports only the reception of the downlink scheme, but a reception scheme may be selected according to a transmission scheme of an opposite terminal that performs the terminal-to-terminal communication if the reception unit has the structure that supports the reception of both the downlink and uplink schemes.

2) Transmission Unit

The transmission unit may have one of a structure that supports only transmission of the uplink scheme and a structure that supports transmission of both the uplink and downlink schemes. Here, only an uplink transmission scheme may be used for terminal-to-terminal communication if the transmission unit has the structure that supports only the transmission of the uplink scheme, but a transmission scheme may be selected according to a reception scheme of an opposite terminal that performs the terminal-to-terminal communication if the transmission unit has the structure that supports the transmission of both the uplink and downlink schemes. In consideration of the structures of the transmission unit and the reception unit capable of being provided in the above-described terminal, the terminal may correspond to one of the following four combinations.

1) Type 1: Device-to-device (D2D) communication is impossible between type-1 terminals, which are legacy terminals of the related art.
The reception unit supports only the reception of the downlink scheme.
The transmission unit supports only the transmission of the uplink scheme.

2) Type 2: Terminal-to-terminal communication uses the downlink scheme.
The reception unit supports only the reception of the downlink scheme.
The transmission unit supports the transmission of both the uplink and downlink schemes.

3) Type 3: Terminal-to-terminal communication uses the uplink scheme.
The reception unit supports the reception of both the downlink and uplink schemes.
The transmission unit supports only the transmission of the uplink scheme.

4) Type 4: Terminal-to-terminal communication may selectively use the uplink and downlink schemes.
The reception unit supports the reception of both the downlink and uplink schemes.
The transmission unit supports the transmission of both the uplink and downlink schemes.

Terminal-to-Terminal Direct Data Transmission/Reception Method

The terminal-to-terminal direct data transmission/reception method will be described below mainly for a frame structure for terminal-to-terminal direct data transmission/reception. The following terminal-to-terminal direct data transmission/reception method may be applied to a D2D link of terminal-to-terminal direct connection communication and terminal-based relaying.

In the following description, it is assumed that the terminal includes one transmission unit and one reception unit. Description divided into a frequency division duplexing (FDD) system and a time division duplexing (TDD) system will be given.

1) FDD System

For terminal-to-terminal direct communication in the FDD system, only one of the following methods may be used, or some or all of the following methods may be used. If some or all methods are used, information regarding a selected method should be included and transmitted in control information to be transferred to the terminal.

First, a first method includes performing terminal-to-terminal direct communication on the basis of all time intervals in which downlink subframe data transmission is possible. In the first method, all terminals joining the terminal-to-terminal direct communication may receive a downlink control channel (physical downlink control channel (PDCCH)) from a base station. Next, a second method includes performing terminal-to-terminal direct communication on the basis of all time intervals in which uplink subframe data transmission is possible. In the second method, only some terminals joining the terminal-to-terminal direct communication may receive the downlink control channel from the base station.

(First Method): Method of performing terminal-to-terminal direct communication on the basis of all time intervals in which downlink subframe data transmission is possible.

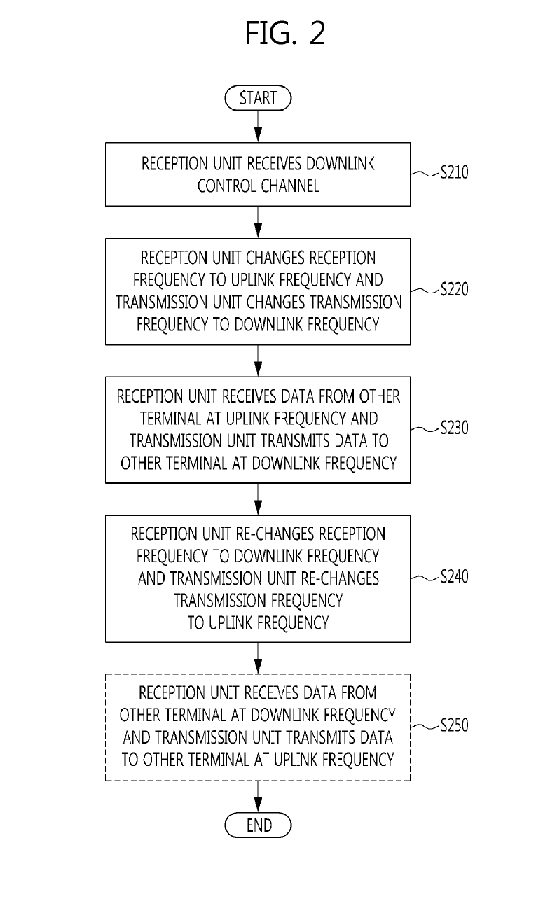

FIG. 2 is a flowchart illustrating a method of performing terminal-to-terminal direct communication on the basis of all time intervals in which downlink subframe data transmission is possible in the FDD system according to the present invention.

Referring to FIG. 2, an example of the terminal-to-terminal direct communication method according to the present invention is a terminal-to-terminal direct data transmission/reception method of a terminal having a transmission unit and a reception unit in a mobile communication system based on FDD (frequency division multiplexing), including the steps of: (a) receiving, by the reception unit, a downlink control channel (S210); (b) after step (a), changing, by the reception unit, a reception frequency to an uplink frequency, and changing, by the transmission unit, a transmission frequency to a downlink frequency (S220); (c) receiving, by the reception unit, data from another terminal at the uplink frequency, and transmitting, by the transmission unit, data to another terminal at the downlink frequency (S230); and (d) re-changing, by the reception unit, the reception frequency to the downlink frequency, and re-changing, by the transmission unit, the transmission frequency to the uplink frequency (S240).

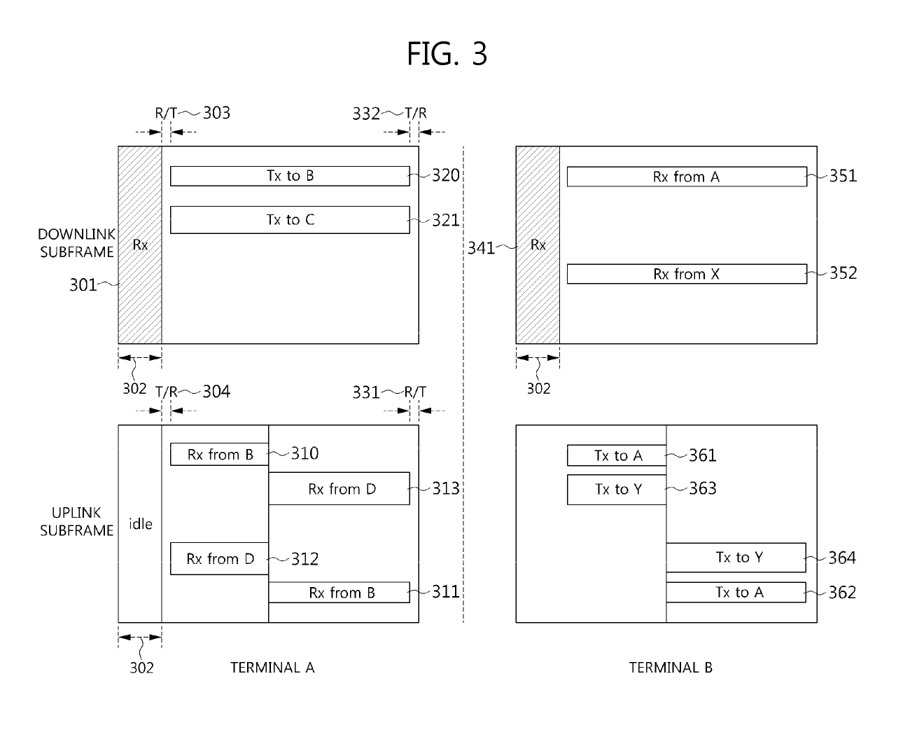

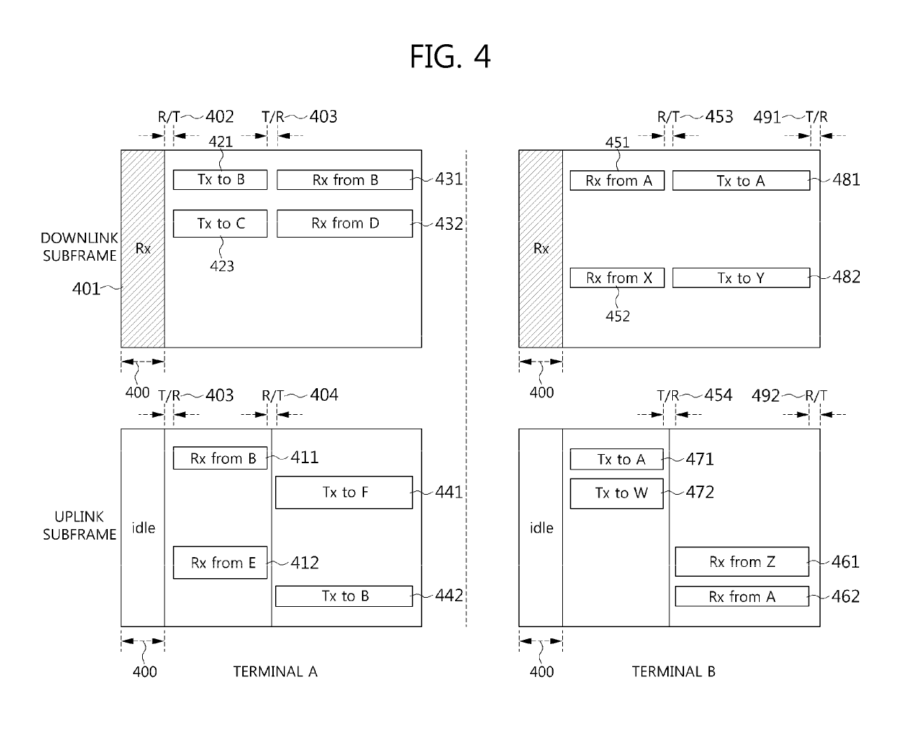

The terminal-to-terminal direct communication method according to the present invention described with reference to FIG. 2 may be divided into a scheme of performing only transmission to another terminal or reception from another terminal using the downlink or uplink frequency within one subframe and a scheme of performing both transmission and reception to and from another terminal using the downlink or uplink frequency within one subframe. The respective schemes will be described below with reference to the frame structures (FIGS. 3 and 4) and the flowchart of FIG. 2.

FIG. 3 is a frame structure diagram illustrating a scheme of performing only transmission to another terminal or reception from another terminal using the downlink (or uplink) frequency in one subframe.

Referring to FIG. 3, in a terminal A allowed to perform transmission to another terminal using the downlink frequency and/or reception from another terminal using the uplink frequency, the reception unit receives a downlink control channel from a base station (S210: 301) and then changes the reception frequency to the uplink frequency at time 304. At time 303, the transmission unit changes the transmission frequency to the downlink frequency (S220). At this time, the transmission unit may stay in an idle state during a downlink control channel time interval 302.

Next, in step S230, the reception unit of the terminal A receives signals 310, 311, 312, and 313 from other terminals (terminals B and D in FIG. 3), and the transmission unit of the terminal A transmits signals 320 and 321 to other terminals (terminals B and C in FIG. 3).

Finally, in step S240, after the terminal-to-terminal data transmission/reception is completed, the reception frequency of the reception unit is re-changed to the downlink frequency at time 331 and the transmission frequency of the transmission unit is re-changed to the uplink frequency at time 332. Accordingly, in the case illustrated in FIG. 3, the terminal is configured only to receive data from another terminal at the uplink frequency, and transmit data to another terminal at the downlink frequency, within a current subframe.

An example in which step S240 is performed at an end time of the current subframe is shown in FIG. 3, but step S240 may be performed at any time within a subframe subsequent to the current subframe. For example, if the base station performs scheduling for the terminal allowed not to receive the downlink control channel (PDCCH) of the subframe subsequent to the current subframe, a frequency re-change (S420) may be made at any time within the subsequent subframe without re-changing the frequency at the end time of the current subframe.

Because the reception frequency of the reception unit is changed to the uplink frequency and the transmission frequency of the transmission unit is changed to the downlink frequency, the terminal A is incapable of receiving data, that is, a downlink traffic data channel (physical downlink shared channel (PDSCH)), between a base station and terminals, and transmitting uplink control and data channels (a physical uplink control channel (PUCCH) and a physical uplink shared channel (PUSCH)). Thus, a scheduler of the base station should perform scheduling in consideration thereof.

On the other hand, in a terminal B allowed to perform reception from another terminal using the downlink frequency and/or transmission to another terminal using the uplink frequency, no frequency change is made in the reception unit and the transmission unit. The reception unit performs data reception 351 and 352 from other terminals (terminals A and X in FIG. 3) after downlink control channel reception 341 using the downlink frequency. The transmission unit performs data transmission 361, 362, 363, and 364 to other terminals (terminals A and Y in FIG. 3) using the uplink frequency. At this time, if lengths of OFDM symbols of a terminal-to-terminal direct link and a base station-terminal link are identical and a reception timing error is in an allowable range, the terminal B may simultaneously receive data (PDSCH) from the base station and simultaneously transmit PUCCH and PUSCH to the base station and another terminal.

In particular, like the terminal B of FIG. 3, a terminal (legacy terminal) not designed to support terminal-to-terminal communication may also receive data from another terminal using the downlink frequency.

In the case of FIG. 3, information indicating that the terminal A performs transmission to another terminal using the downlink frequency and/or reception from another terminal using the uplink frequency and information indicating that the terminal B performs reception from another terminal using the downlink frequency and/or transmission to another terminal using the uplink frequency may be transferred through a control channel of a corresponding subframe or its previous subframe, or may be transferred in the form of higher-layer control information for semi-permanently allocating resources. That is, because the terminal A and the terminal B may perform terminal-to-terminal direct communication using all time intervals in which downlink subframe data transmission is possible, a downlink control channel may be received and hence the above-described information may be received from a downlink control channel (PDCCH) of a corresponding downlink subframe.

FIG. 4 is a frame structure diagram illustrating a scheme of performing both transmission to another terminal and reception from another terminal using a downlink (or uplink) frequency in one subframe.

Referring to FIG. 4, in the terminal A allowed to perform reception after transmission to another terminal using the downlink frequency and/or transmission after reception from another terminal using the uplink frequency, the reception unit receives a downlink control channel from the base station (S210: 401). Thereafter, the reception unit changes the reception frequency to the uplink frequency at time 403, and the transmission unit changes the transmission frequency to the downlink frequency at time 402 (S220).

At this time, the transmission unit may stay in the idle state during a downlink control channel time interval 400.

Next, in step S230, the reception unit of the terminal A performs signal reception 411 and 412 from other terminals (terminals B and E in FIG. 4), and the transmission unit of the terminal A performs signal transmission 421 and 422 to other terminals (terminals B and C in FIG. 4).

Finally, in step S240, after the terminal-to-terminal data transmission/reception is completed, the reception frequency of the reception unit is re-changed to the downlink frequency at time 403 and the transmission frequency of the transmission unit is re-changed to the uplink frequency at time 404.

If the frame structure diagram of FIG. 3 is compared with that of FIG. 4, there is a difference in that step S240 is performed at an end time of a subframe (303 or 304: any time of a subframe subsequent to a current subframe) in FIG. 3, but is performed at time 403 or 404 of a subframe in FIG. 4. That is, in FIG. 4, the reception unit of the terminal A performs signal reception 431 and 432 from other terminals (terminals B and D of FIG. 4) by re-changing the reception frequency to the downlink frequency in step S240, and the transmission unit of the terminal A additionally performs step S250 of performing data transmission 441 and 442 to other terminals (terminals F and B in FIG. 4) by changing the transmission frequency to the uplink frequency, so that transmission to another terminal and reception from another terminal may all be performed in one subframe.

On the other hand, in the terminal B allowed to perform transmission after reception from another terminal using the downlink frequency and/or reception after transmission to another terminal using the uplink frequency, the reception unit performs data reception 451 and 452 from other terminals (terminals A and X in FIG. 4) using the downlink frequency, and then performs signal reception 461 and 462 from other terminals (terminals Z and A in FIG. 4) by changing the reception frequency to the uplink frequency at time 453. The transmission unit is in the idle state during a downlink control channel time interval 400, and then performs data transmission 481 and 482 to other terminals (terminals A and Y in FIG. 4) by changing the reception frequency to the downlink frequency at time 454 after data transmission 471 and 472 to other terminals (terminals A and W in FIG. 4) using the uplink frequency. At subframe ends 491 and 492 after terminal-to-terminal data transmission/reception is completed, the reception frequency of the reception unit is re-changed to the downlink frequency and the transmission frequency of the transmission unit is re-changed to the uplink frequency.

On the other hand, in the case of FIG. 4, information indicating that the terminal A is allowed to perform reception from another terminal after transmission to another terminal using the downlink frequency and/or transmission to another terminal after reception from another terminal using the uplink frequency and information indicating that the terminal B is allowed to perform transmission to another terminal after reception from another terminal using the downlink frequency and/or reception from another terminal after transmission to another terminal using the uplink frequency may be transferred through a control channel of a corresponding subframe or its previous subframe, or may be transferred in the form of higher-layer control information for semi-permanently allocating resources. That is, because the terminal A and the terminal B may perform terminal-to-terminal direct communication using all time intervals in which downlink subframe data transmission is possible, a downlink control channel may be received and hence the above-described information may be received from a downlink control channel (PDCCH) of a corresponding downlink subframe.

Referring to FIG. 4, boundary time 403, 404, 453, or 454 when switching from transmission to another terminal (reception from another terminal) to reception from another terminal (transmission to another terminal) is performed may be fixed or changed. When the change is possible, boundary time 403, 404, 453, or 454 may be determined and reported by the base station, but may be additionally changed by a negotiation through a terminal-to-terminal signaling exchange. In the above case, a downlink boundary may be different from an uplink boundary.

Because the terminal A and the terminal B are incapable of receiving data, that is, a downlink traffic data channel (PDSCH in FIG. 4), between the base station and the terminals, and transmitting uplink control and data channels (PUCCH and PUSCH in FIG. 4), a scheduler of the base station should perform scheduling in consideration thereof.

If a transition time for a frequency change is small enough to be negligible in the transmission unit and the reception unit, the same OFDM symbol length as that of a base station-terminal link is applied even in the terminal-to-terminal direct communication. Otherwise, a symbol length or the number of symbols should be reduced by a method of reducing a cyclic prefix (CP) length, or the like. If resource allocation information for the terminal-to-terminal direct communication using the downlink frequency is transferred through a control channel of a corresponding subframe during the terminal-to-terminal direct communication, a guard time of one or more OFDM symbols may be necessary until a transmission start time after downlink control channel reception.

In the terminal-to-terminal direct data transmission/reception method of the terminal according to the present invention, the terminal may be configured to directly transmit/receive data to/from a plurality of terminals within the same subframe as illustrated in FIGS. 3 and 4. A plurality of terminals may simultaneously receive data transmitted from the terminal to other terminals at the downlink frequency. This may be used in a local multicast/broadcast application.

(Second Method): Method of performing terminal-to-terminal direct communication on the basis of all time intervals in which uplink subframe data transmission is possible

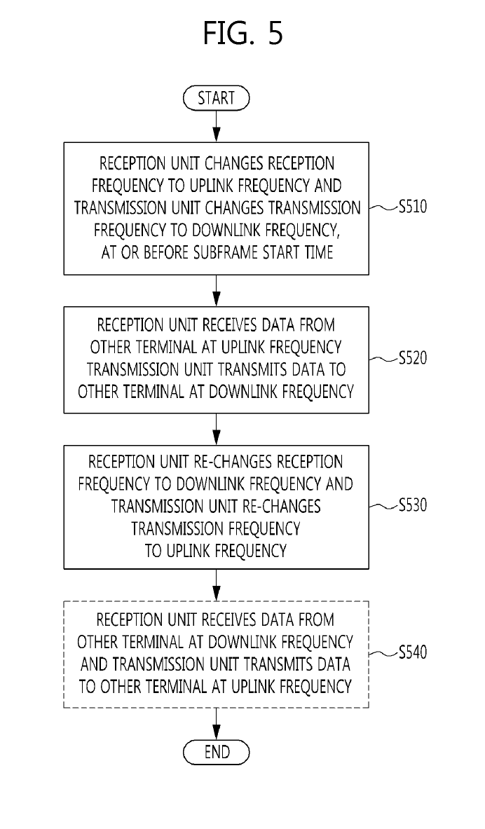

FIG. 5 is a flowchart illustrating a method of performing terminal-to-terminal direct communication on the basis of all time intervals in which uplink subframe data transmission is possible in the FDD system according to the present invention.

Referring to FIG. 5, another example of the terminal-to-terminal direct communication method according to the present invention is a terminal-to-terminal direct data transmission/reception method of a terminal having a transmission unit and a reception unit in a mobile communication system based on FDD (frequency division multiplexing), including the steps of: (a) changing, by the reception unit, a reception frequency to an uplink frequency, and changing, by the transmission unit, a transmission frequency to a downlink frequency, at or before a current subframe start time (S510); (b) after step (a), receiving, by the reception unit, data from another terminal at the uplink frequency, or transmitting, by the transmission unit, data to another terminal at the downlink frequency after staying in an idle state during a subframe downlink control channel interval (S520); and (c) re-changing, by the reception unit, the reception frequency to the downlink frequency, and re-changing, by the transmission unit, the transmission frequency to the uplink frequency (S530).

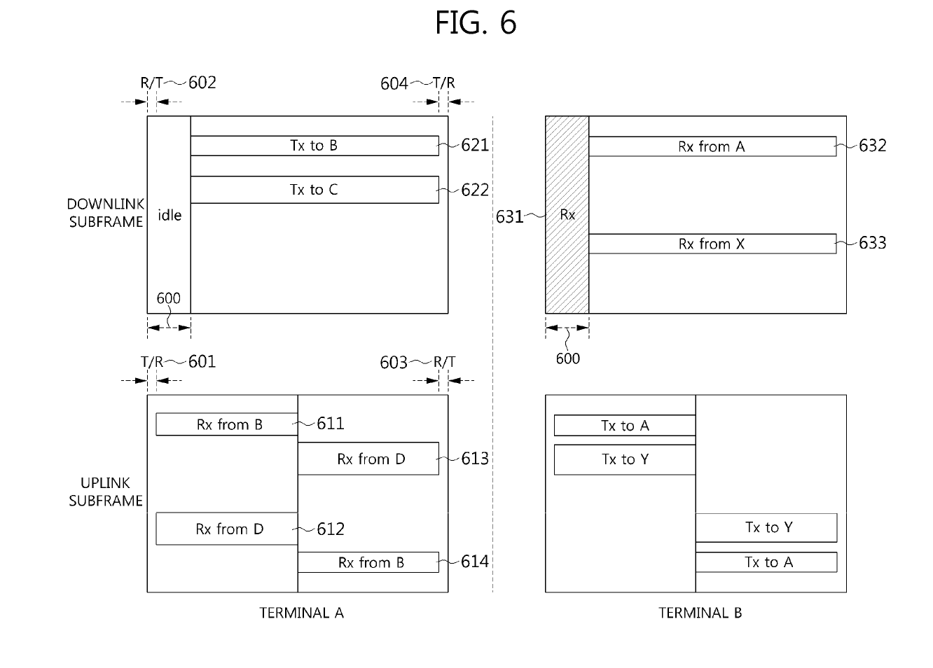

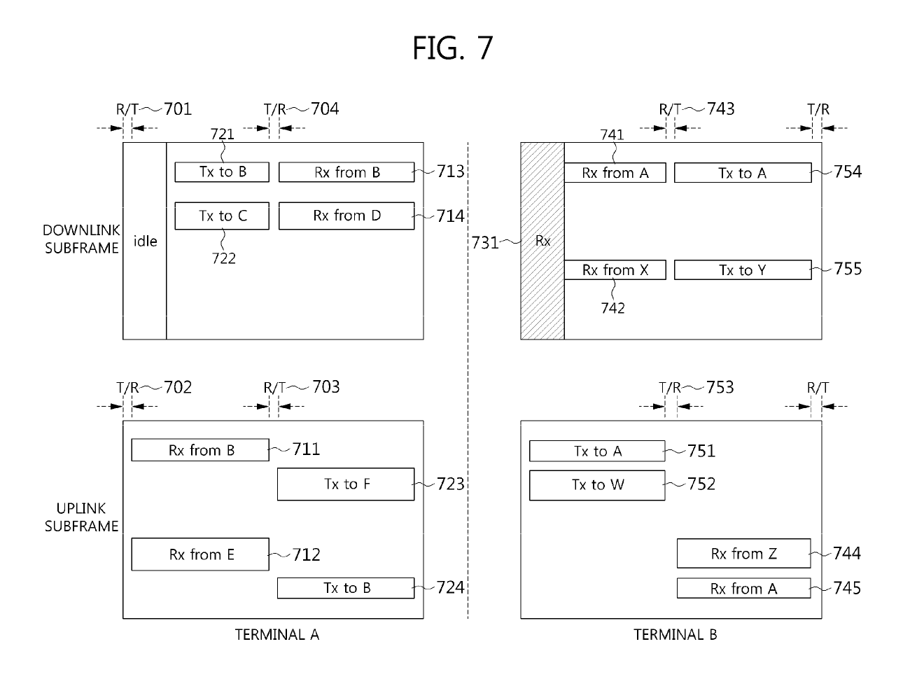

The terminal-to-terminal direct communication method according to the present invention described with reference to FIG. 5 may be divided into a scheme of performing only transmission to another terminal or reception from another terminal using the downlink or uplink frequency within one subframe and a scheme of performing both transmission and reception to and from another terminal using the downlink or uplink frequency within one subframe. The respective schemes will be described below with reference to the frame structures (FIGS. 6 and 7) and the flowchart of FIG. 5.

FIG. 6 is a frame structure diagram illustrating a scheme of performing only transmission to another terminal or reception from another terminal using the downlink (or uplink) frequency in one subframe.

Referring to FIG. 6, in a terminal A allowed to perform transmission to another terminal using the downlink frequency and/or reception from another terminal using the uplink frequency, the reception unit changes the reception frequency to the uplink frequency at subframe start time 601 or a time previous to a current subframe, and the transmission unit changes the transmission frequency to the downlink frequency at subframe start time 602 or a time previous to a current subframe (S510).

The reception unit of the terminal A performs signal reception 611, 612, 613, and 614 from other terminals (terminals B and D in FIG. 6), and the transmission unit of the terminal A performs data transmission 621 and 622 to other terminals (terminals B and C in FIG. 6) (S520). Here, the transmission unit of the terminal A may be configured to stay in the idle state during a downlink control channel time interval 600 after changing the transmission frequency to the downlink frequency at subframe start time 602, which is a frequency change time, or the time previous to the current subframe.

In step S530, at end time 603 or 604 of the current subframe after terminal-to-terminal transmission/reception or any time within a subframe subsequent to the current subframe, the reception frequency of the reception unit is re-changed to the downlink frequency, and the transmission frequency of the transmission unit is re-changed to the uplink frequency. Accordingly, in the case illustrated in FIG. 6, the terminal is configured only to receive data from another terminal at the uplink frequency, and transmit data to another terminal at the downlink frequency, within the current subframe.

An example in which step S530 is performed at an end time of a current subframe is shown in FIG. 6, but step S530 may be performed at any time within a subframe subsequent to the current subframe. For example, if the base station performs scheduling for the terminal not allowed to receive a downlink control channel (PDCCH) of a subframe subsequent to the current subframe, a frequency re-change (S530) may be made not at the end time of the current subframe but at any time within the subsequent subframe.

Because the terminal A is incapable of receiving data, that is, a downlink traffic data channel (PDSCH in FIG. 6), between the base station and the terminals and transmitting uplink control and data channels (PUCCH and PUSCH in FIG. 6), a scheduler of the base station should perform scheduling in consideration thereof.

On the other hand, in the case of the terminal B allowed to perform reception from another terminal using the downlink frequency and/or transmission to another terminal using the uplink frequency, no frequency change is made in the reception unit and the transmission unit as in the first method described above with reference to FIGS. 2 to 4. The reception unit performs data reception 632 and 633 from other terminals (terminals A and X in FIG. 6) after downlink control channel reception 631 using the downlink frequency. At this time, if timing errors of reception signals from the base station and another terminal are in an allowable range, data from the base station may also be simultaneously received. Likewise, also in the case of the transmission, transmission to the base station and another terminal may be simultaneously performed.

Like the terminal B of FIG. 6, a terminal (legacy terminal) not designed to support terminal-to-terminal communication may also transmit data to another terminal using the uplink frequency.

Information indicating that the terminal A is allowed to perform transmission to another terminal using the downlink frequency and/or reception from another terminal using the uplink frequency may be transferred through a control channel of its previous subframe, or may be transferred in the form of higher-layer control information for semi-permanently allocating resources. Also, information indicating that the terminal B is allowed to perform reception from another terminal using the downlink frequency and/or transmission to another terminal using the uplink frequency may be transferred through a control channel of a corresponding subframe (only in the case of reception-related control information) or a previous subframe, or may be transferred in the form of higher-layer control information for semi-permanently allocating resources.

FIG. 7 is a frame structure diagram illustrating a scheme of performing both transmission to another terminal and reception from another terminal using the downlink or uplink frequency in one subframe.

Referring to FIG. 7, in the terminal A allowed to perform reception after transmission to another terminal using the downlink frequency and/or transmission after reception from another terminal using the uplink frequency, the reception unit changes the reception frequency to the uplink frequency at end time 701 of a current subframe or a time previous to the current subframe, and the transmission unit changes the transmission frequency to the downlink frequency at start time 702 of a current subframe or a time previous to the current subframe (S510).

In step S520, the reception unit of the terminal A performs signal reception 711 and 712 from other terminals (terminals B and E in FIG. 7), and the transmission unit of the terminal A performs signal transmission 721 and 722 to other terminals (terminals B and C in FIG. 7).

In step S530, the reception unit of the terminal A re-changes the reception frequency to the downlink frequency at time 703 within a subframe time interval, and the transmission unit of the terminal B re-changes the transmission frequency to the uplink frequency at time 704 within a subframe time interval.

If the frame structure diagram of FIG. 6 is compared with that of FIG. 7, there is a difference in that step S530 is performed at subframe end time 603 or 604 or any time of a subframe subsequent to a current subframe in FIG. 6, but is performed at time 703 or 704 within a subframe interval in FIG. 7. That is, in FIG. 7, the reception unit of the terminal A performs signal reception 713 and 714 from other terminals (terminals B and D of FIG. 7) by re-changing the reception frequency to the downlink frequency in step S530, and the transmission unit of the terminal A additionally includes step S540 of performing data transmission 723 and 724 to other terminals (terminals F and B in FIG. 7) by changing the transmission frequency to the uplink frequency, so that transmission to another terminal and reception from another terminal may all be performed in one subframe.

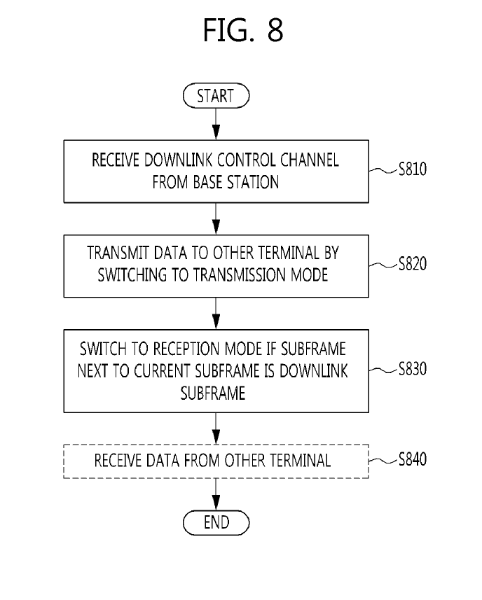

On the other hand, in the terminal B allowed to perform transmission after reception from another terminal using the downlink frequency and/or reception after transmission to another terminal using the uplink frequency, the reception unit performs data reception 741 and 741 from other terminals (terminals A and X in FIG. 7) after downlink control channel reception 731 using the downlink frequency, and then performs signal reception 744 and 745 from other terminals (terminals Z and A in FIG. 7) by changing the reception frequency to the uplink frequency at time 743. After the transmission unit performs data transmission 751 and 752 to other terminals (terminals A and W in FIG. 7) using the uplink frequency, the reception frequency is changed to the downlink frequency at time 753 in accordance with time 743 when the reception unit changes the reception frequency to the uplink frequency, and data transmission 754 and 755 to other terminals (terminals A and Y in FIG. 8) is performed. At a subframe end or a time within a subframe subsequent to a current subframe after terminal-to-terminal data transmission/reception is completed, the reception frequency of the reception unit is re-changed to the downlink frequency and the transmission frequency of the transmission unit is re-changed to the uplink frequency.

Information indicating that the terminal A is allowed to perform reception after transmission to another terminal using the downlink frequency and/or transmission after reception from another terminal using the uplink frequency may be transferred through a control channel of its previous subframe, or may be transferred in the form of higher-layer control information for semi-permanently allocating resources. Also, information indicating that the terminal B is allowed to perform transmission after reception from another terminal using the downlink frequency and/or reception after transmission to another terminal using the uplink frequency may be transferred through a control channel of a corresponding subframe (only in the case of reception-related control information) or its previous subframe, or may be transferred in the form of higher-layer control information for semi-permanently allocating resources.

Referring to FIG. 7, boundary time 703, 704, 743, or 753 when switching from transmission to another terminal (reception from another terminal) to reception from another terminal (transmission to another terminal) is performed may be fixed or changed. When the change is possible, boundary time 703, 704, 743, or 753 may be determined and reported by the base station, but may be additionally changed by a negotiation through a terminal-to-terminal signaling exchange. In the above case, a downlink boundary may be different from an uplink boundary.

Because the terminal A and the terminal B are incapable of receiving data, that is, a downlink traffic data channel (PDSCH in FIG. 7), between the base station and the terminals and transmitting uplink control and data channels (PUCCH and PUSCH in FIG. 7), a scheduler of the base station should perform scheduling in consideration thereof.

In the terminal-to-terminal direct data transmission/reception method of the terminal according to the present invention, the terminal may be configured to simultaneously directly transmit/receive data to/from a plurality of terminals within the same subframe as illustrated in FIGS. 6 and 7. A plurality of terminals may simultaneously receive data transmitted from the terminal to other terminals at the downlink or uplink frequency. This may be used in a local multicast/broadcast application.

2) TDD System

A terminal-to-terminal direct data reception method for use in the TDD system in which a terminal includes one reception unit and one transmission unit and is switched to a transmission mode and a reception mode at a necessary time will be described.

For terminal-to-terminal direct communication in the TDD system, only one of the following methods may be used and some or all of the following methods may be used. If some or all methods are used, information regarding a selected method should be included and transmitted in control information to be transferred to the terminal.

In a first method, terminal-to-terminal direct communication is performed within a downlink subframe, and in a second method, terminal-to-terminal direct communication is performed within an uplink subframe.

(First Method): Method of performing terminal-to-terminal direct communication within downlink subframe

FIG. 8 is a flowchart illustrating the method of performing terminal-to-terminal direct communication within a downlink subframe in the TDD system according to the present invention.

Referring to FIG. 8, in the method of performing terminal-to-terminal direct communication within a downlink subframe, terminal-to-terminal direct data transmission/reception is performed within a downlink subframe in a mobile communication system based on TDD (time division multiplexing), which includes the steps of: (a) receiving a downlink control channel from a base station (S810); (b) after step (a), transmitting data to another terminal by switching to a transmission mode (S820); and (c) switching to a reception mode if a subframe next to a current subframe is a downlink subframe (S830).

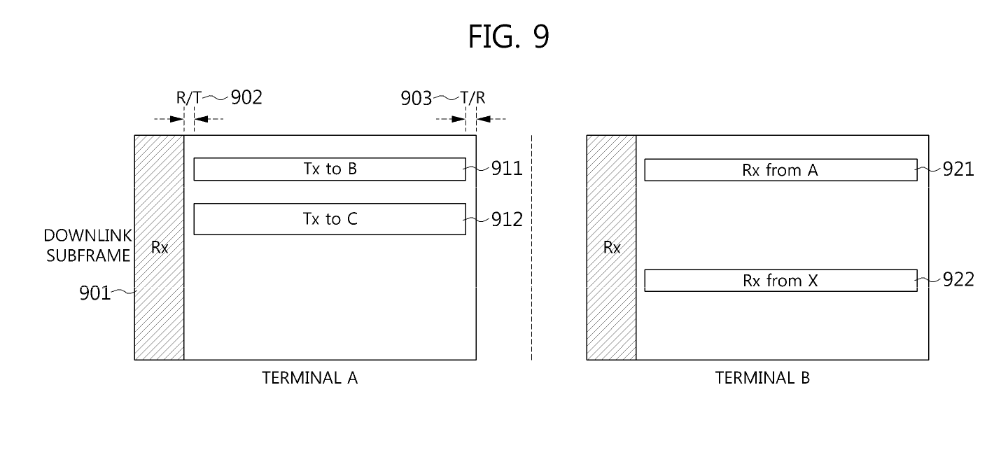

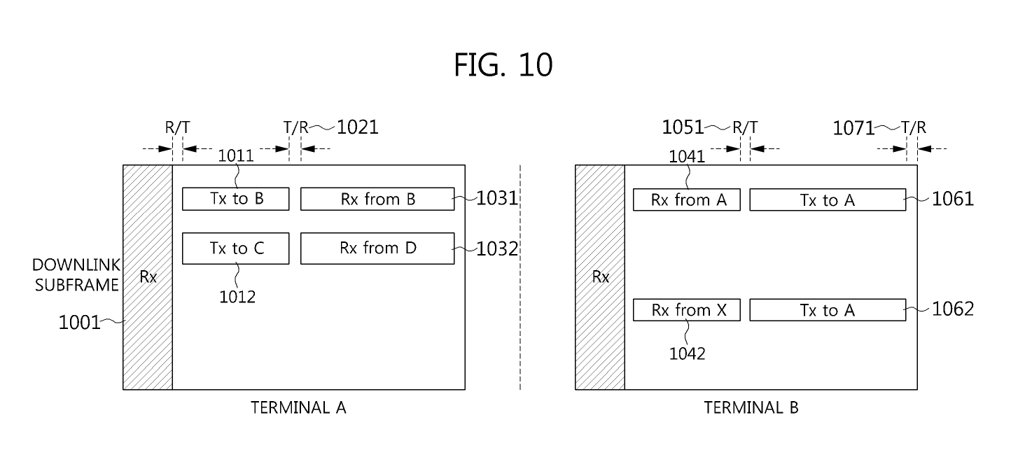

The terminal-to-terminal direct communication method according to the present invention described with reference to FIG. 8 may be divided into a scheme of performing only transmission to another terminal or reception from another terminal using the downlink or uplink frequency within one downlink subframe and a scheme of performing both transmission and reception to and from another terminal using the downlink or uplink frequency within one subframe. The respective schemes will be described below with reference to the frame structures (FIGS. 9 and 10) and the flowchart of FIG. 8.

FIG. 9 is a frame structure diagram illustrating a scheme of performing only transmission to another terminal or reception from another terminal on the basis of all time intervals in which downlink subframe data transmission is possible.

Referring to FIG. 9, a terminal A allowed to perform transmission to another terminal in a downlink subframe is switched to the transmission mode at time 902 after downlink control channel reception (S810: 901), performs data transmission 911 and 912 to other terminals (terminals B and C in FIG. 9) (S820), and is re-switched to the reception mode at subframe end time 903 after terminal-to-terminal data transmission is completed (S830). However, the transmission mode may be maintained according to a type of next subframe or if necessary. That is, in step S830, switching to the reception mode may be performed if a subframe next to a current subframe is a downlink subframe.

Because the terminal A is incapable of receiving data, that is, a downlink traffic data channel (PDSCH), between the base station and the terminals, a scheduler of the base station should perform scheduling in consideration thereof.

On the other hand, a terminal B allowed to perform reception from another terminal in the downlink subframe performs data reception 921 and 922 from other terminals (terminals A and X in FIG. 9) after downlink control channel reception from the base station. At this time, if a condition (for example, that lengths of OFDM symbols of a terminal-to-terminal direct link and a base station-terminal link are identical and a reception timing error is in an allowable range) is satisfied, data from the base station may also be simultaneously received.

Information indicating that the terminal A is allowed to perform transmission to another terminal in the downlink subframe may be transferred through a control channel of a corresponding subframe or its previous subframe, or may be transferred in the form of higher-layer control information for semi-permanently allocating resources. Also, information indicating that the terminal B is allowed to perform reception from another terminal in the downlink subframe may be transferred through a control channel of a corresponding subframe or its previous subframe, or may be transferred in the form of higher-layer control information for semi-permanently allocating resources.

FIG. 10 is a frame structure diagram illustrating a scheme of performing both transmission to another terminal and reception from another terminal on the basis of all time intervals in which downlink subframe data transmission is possible.

Referring to FIG. 10, the terminal A allowed to perform reception after transmission to another terminal in the downlink subframe is switched to the transmission mode after downlink control channel reception 1001 from the base station (S810), performs data transmission 1011 and 1012 to other terminals (terminals B and C in FIG. 10) (S820), is re-switched to the reception mode at time 1021 within a subframe interval (S830), and performs data reception 1031 and 1032 from other terminals (terminals B and D in FIG. 10) (S840).

On the other hand, the terminal B allowed to perform transmission after reception in the downlink subframe first performs data reception 1041 and 1042 from other terminals (terminals A and X in FIG. 10), is re-switched to the transmission mode at time 1051 within a subframe interval, and is re-switched to the reception mode at subframe end time 1071 after data transmission 1061 and 1062 to other terminals (terminals A and Y in FIG. 10). However, the reception mode may be maintained according to a type of next subframe or if necessary.

Information indicating that the terminal A is allowed to perform reception after transmission to another terminal in the downlink subframe may be transferred through a control channel of a corresponding subframe or its previous subframe, or may be transferred in the form of higher-layer control information for semi-permanently allocating resources. Also, information indicating that the terminal B is allowed to perform transmission after reception from another terminal in the downlink subframe may be transferred through a control channel of a corresponding subframe or its previous subframe, or may be transferred in the form of higher-layer control information for semi-permanently allocating resources.

That is, if the frame structure diagram of FIG. 9 is compared with that of FIG. 10, step S820 is performed at a subframe end in FIG. 9, but is performed within a subframe interval in FIG. 10, so that both transmission to another terminal and reception from another terminal may be performed within one subframe.

In the terminal-to-terminal direct data transmission/reception method of the terminal according to the present invention, the terminal may be configured to simultaneously directly transmit/receive data to/from a plurality of terminals within the same subframe as illustrated in FIGS. 9 and 10. A plurality of terminals may simultaneously receive data that the terminal transmits to other terminals in the transmission mode. This may be used in a local multicast/broadcast application.

(Second Method): Method of performing terminal-to-terminal direct communication within uplink subframe

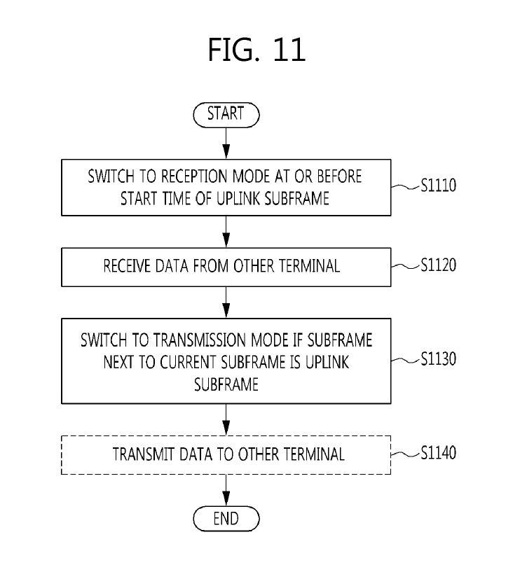

FIG. 11 is a flowchart illustrating a method of performing terminal-to-terminal direct communication within an uplink subframe in the TDD system according to the present invention.

Referring to FIG. 11, another example of the terminal-to-terminal direct communication according to the present invention is a method of performing terminal-to-terminal direct data transmission/reception within an uplink subframe in a mobile communication system based on TDD (time division multiplexing), including the steps of: (a) switching to a reception mode at or before a start time of an uplink subframe (S1110); (b) after step (a), receiving data from another terminal (S1120); and (c) switching to a transmission mode if a subframe next to a current subframe is an uplink subframe (S1130).

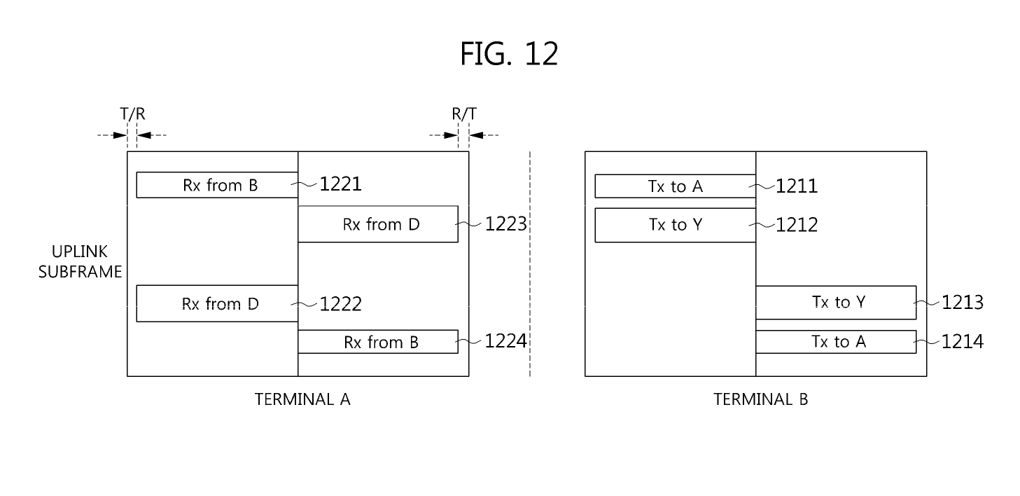

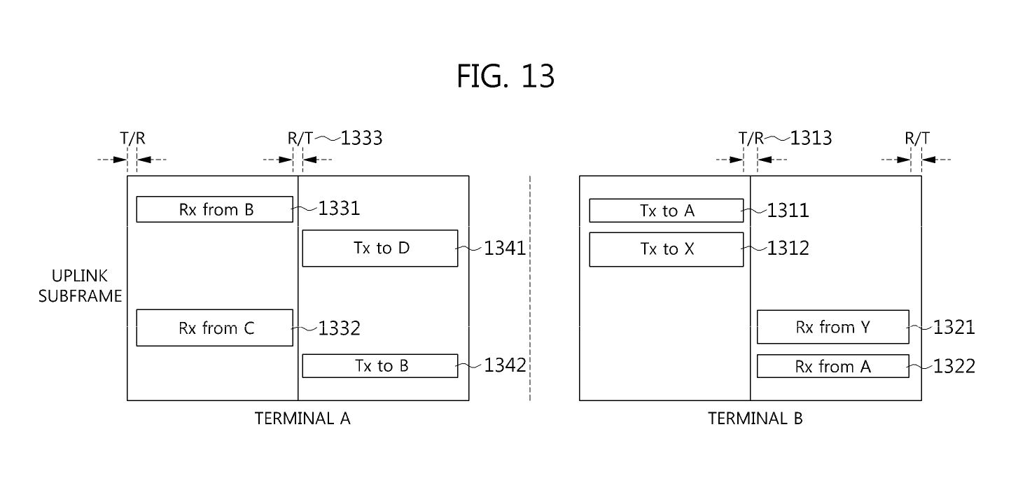

The terminal-to-terminal direct communication method according to the present invention described with reference to FIG. 11 may be divided into a scheme of performing only transmission to another terminal or reception from another terminal using the downlink or uplink frequency within one uplink subframe and a scheme of performing both transmission and reception to and from another terminal using the downlink or uplink frequency within one uplink subframe. The respective schemes will be described below with reference to the frame structures (FIGS. 12 and 13) and the flowchart of FIG. 11.

FIG. 12 is a frame structure diagram illustrating a scheme of performing only transmission to another terminal or reception from another terminal on the basis of all time intervals in which uplink subframe data transmission is possible according to the present invention.

Referring to FIG. 12, the terminal A allowed to perform reception from another terminal in the uplink subframe is switched to the reception mode at or before a start time of the uplink subframe, and re-switched to the transmission mode at a subframe end or a time within a subframe subsequent to a current subframe after data reception 1221, 1222, 1223, and 1224 from other terminals (terminals B and D in FIG. 12). However, the reception mode may be maintained according to a type of next subframe or if necessary. That is, in step S1130, switching to the transmission mode may be performed if the next subframe is an uplink subframe.

Information indicating that the terminal A is allowed to perform reception from another terminal in the uplink subframe may be transferred through a control channel of its previous subframe, or may be transferred in the form of higher-layer control information for semi-permanently allocating resources.

Because the terminal A is incapable of transmitting uplink control and data channels (PUCCH and PUSCH), a scheduler of the base station should perform scheduling in consideration thereof.

On the other hand, the terminal B allowed to perform transmission to another terminal in the uplink subframe performs data transmission 1211, 1212, 1213, and 1214 to other terminals (terminals A and Y in FIG. 12).

Here, information indicating that the terminal B is allowed to perform transmission to another terminal in the uplink subframe may be transferred through a control channel of its previous subframe, or may be transferred in the form of higher-layer control information for semi-permanently allocating resources. At this time, if a condition (for example, that lengths of OFDM symbols of a terminal-to-terminal direct link and a base station-terminal link are identical and a transmission timing error is in an allowable range) is satisfied, it is possible to simultaneously transmit data to the base station.

FIG. 13 is a frame structure diagram illustrating a scheme of performing both transmission to another terminal and reception from another terminal in an uplink subframe according to the present invention.

Referring to FIG. 13, the terminal A allowed to perform transmission after reception from another terminal in the uplink subframe perform data reception 1331 and 1332 from other terminals (terminals B and C in FIG. 13) after switching to the reception mode at or before a subframe start time, and performs data transmission 1341 and 1342 to other terminals (terminals D and B in FIG. 13) by switching to the transmission mode at time 1333 within a subframe. According to a type of next subframe or if necessary, the transmission mode may be maintained, or switching to the reception mode may be performed. That is, the transmission mode may be maintained if the next subframe is an uplink subframe, and switching to the reception mode may be performed if the next subframe is a downlink subframe.

Information indicating that the terminal A is allowed to perform transmission after reception from another terminal in the uplink subframe may be transferred through a control channel of its previous subframe, or may be transferred in the form of higher-layer control information for semi-permanently allocating resources.

On the other hand, the terminal B allowed to perform reception after transmission to another terminal in the uplink subframe performs data transmission 1311 and 1312 to other terminals (terminals A and X in FIG. 13) in the transmission mode (S1110), performs data reception 1321 and 1322 from other terminals (terminals Y and A in FIG. 13) by switching to the reception mode at time 1313 within a subframe (S1120), and then is re-switched to the transmission mode at a subframe end.

Information indicating that the terminal B is allowed to perform reception after transmission to another terminal in the downlink subframe may be transferred through a control channel of its previous subframe, or may be transferred in the form of higher-layer control information for semi-permanently allocating resources.

That is, if the frame structure diagram of FIG. 12 is compared with that of FIG. 13, step S1130 is performed at an end time of a current subframe or within a subframe subsequent to the current subframe in FIG. 12, but is performed at time 1313 or 1333 within a subframe interval in FIG. 13, so that both transmission to another terminal and reception from another terminal may be performed within one subframe.

Referring to FIG. 13, boundary time 1313 or 1333 when switching from transmission to another terminal (reception from another terminal) to reception from another terminal (transmission to another terminal) is performed may be fixed or changed. When the change is possible, boundary time 1313 or 1333 may be determined and reported by the base station, but may be additionally changed by a negotiation through a terminal-to-terminal signaling exchange.

Because the terminal A and the terminal B are incapable of transmitting data, that is, uplink control and data channels (PUCCH and PUSCH in FIG. 13), between the base station and the terminals, a scheduler of the base station should perform scheduling in consideration thereof.

In the terminal-to-terminal direct data transmission/reception method of the terminal according to the present invention, the terminal may be configured to simultaneously directly transmit/receive data to/from a plurality of terminals within the same subframe as illustrated in FIGS. 12 and 13. A plurality of terminals may simultaneously receive data that the terminal transmits to other terminals in the transmission mode. This may be used in a local multicast/broadcast application.

Although the present invention has been described with reference to the above embodiments, it should be understood that those skilled in the art may make various other modifications and changes without departing from the spirit and scope of the invention as defined by the appended claims.

1. A terminal-to-terminal direct data transmission/reception method of a terminal having a transmission unit and a reception unit in a mobile communication system based on FDD, comprising the steps of:
(a) receiving, by the reception unit, a downlink control channel;
(b) after step (a), changing, by the reception unit, a reception frequency to an uplink frequency, and changing, by the transmission unit, a transmission frequency to a downlink frequency;
(c) receiving, by the reception unit, data from another terminal at the uplink frequency, or transmitting, by the transmission unit, data to another terminal at the downlink frequency; and
(d) re-changing, by the reception unit, the reception frequency to the downlink frequency, and re-changing, by the transmission unit, the transmission frequency to the uplink frequency.

2. The terminal-to-terminal direct data transmission/reception method according to claim 1, wherein a point in time when step (d) is performed is an end time of a current subframe or a time within a subframe subsequent to the current subframe, and
the terminal only receives data from another terminal at the uplink frequency, and/or transmits data to another terminal at the downlink frequency, within the current subframe.

3. The terminal-to-terminal direct data transmission/reception method according to claim 1, further comprising, after step (d), the step of (e) receiving, by the reception unit, data from another terminal at the downlink frequency, and/or transmitting, by the transmission unit, data to another terminal at the uplink frequency, within the subframe time interval,
wherein a point in time when step (d) is performed is within a current subframe time interval.

4. The terminal-to-terminal direct data transmission/reception method according to claim 1, wherein the terminal simultaneously directly transmits/receives data to/from a plurality of terminals within the same subframe.

5. The terminal-to-terminal direct data transmission/reception method according to claim 1, wherein a plurality of terminals simultaneously receive data transmitted from the terminal to other terminals at the downlink frequency.

6. A terminal-to-terminal direct data transmission/reception method of a terminal having a transmission unit and a reception unit in a mobile communication system based on FDD, comprising the steps of:
(a) changing, by the reception unit, a reception frequency to an uplink frequency, and changing, by the transmission unit, a transmission frequency to a downlink frequency, at or before a subframe start time;
(b) after step (a), receiving, by the reception unit, data from another terminal at the uplink frequency, or transmitting, by the transmission unit, data to another terminal at the downlink frequency after staying in an idle state during a subframe downlink control channel interval; and
(c) re-changing, by the reception unit, the reception frequency to the downlink frequency, and re-changing, by the transmission unit, the transmission frequency to the uplink frequency.

7. The terminal-to-terminal direct data transmission/reception method according to claim 6, wherein a point in time when step (c) is performed is an end time of a current subframe or a time within a subframe subsequent to the current subframe, and
the terminal only receives data from another terminal at the uplink frequency, and/or transmits data to another terminal at the downlink frequency, within the current subframe.

8. The terminal-to-terminal direct data transmission/reception method according to claim 6, further comprising, after step (c), the step of (d) receiving, by the reception unit, data from another terminal at the downlink frequency, and/or transmitting, by the transmission unit, data to another terminal at the uplink frequency, within the subframe time interval,
wherein a point in time when step (c) is performed is within a current subframe time interval.

9. The terminal-to-terminal direct data transmission/reception method according to claim 6, wherein the terminal simultaneously directly transmits/receives data to/from a plurality of terminals within the same subframe.

10. The terminal-to-terminal direct data transmission/reception method according to claim 6, wherein a plurality of terminals simultaneously receive data transmitted from the terminal to other terminals at the downlink frequency or the uplink frequency.

11. A terminal-to-terminal direct data transmission/reception method of a terminal within a downlink subframe in a mobile communication system based on TDD, comprising the steps of:
(a) receiving a downlink control channel from a base station;
(b) after step (a), transmitting data to another terminal by switching to a transmission mode; and
(c) switching to a reception mode if a subframe next to a current subframe is a downlink subframe.

12. The terminal-to-terminal direct data transmission/reception method according to claim 11, wherein a point in time when step (c) is performed is an end time of a current downlink subframe or a time within a subframe subsequent to the current downlink subframe.

13. The terminal-to-terminal direct data transmission/reception method according to claim 11, further comprising, after step (c), the step of (d) receiving data from another terminal within a current downlink subframe time interval,
wherein step (c) is performed within a current subframe time interval.

14. The terminal-to-terminal direct data transmission/reception method according to claim 11, wherein the terminal simultaneously directly transmits/receives data to/from a plurality of terminals within the same subframe.

15. The terminal-to-terminal direct data transmission/reception method according to claim 11, wherein a plurality of terminals simultaneously receive data transmitted from the terminal to other terminals in the transmission mode.

16. A terminal-to-terminal direct data transmission/reception method of a terminal within an uplink subframe in a mobile communication system based on TDD, comprising the steps of:
(a) switching to a reception mode at or before a start time of an uplink subframe;
(b) after step (a), receiving data from another terminal; and
(c) switching to a transmission mode if a subframe next to a current subframe is an uplink subframe.

17. The terminal-to-terminal direct data transmission/reception method according to claim 16, wherein a point in time when step (c) is performed is an end time of a current uplink subframe or a time within a subframe subsequent to the current uplink subframe.

18. The terminal-to-terminal direct data transmission/reception method according to claim 16, further comprising, after step (c), the step of (d) transmitting data to another terminal within a current uplink subframe time interval,
wherein step (c) is performed within a current subframe time interval.

19. The terminal-to-terminal direct data transmission/reception method according to claim 16, wherein the terminal simultaneously directly transmits/receives data to/from a plurality of terminals within the same subframe.
